(19) United States
(12) Patent Application Publication
(10) Pub. No.: US 2012/0226935 A1
(43) Pub. Date: Sep. 6, 2012

(54) VIRTUAL RAID-1 DRIVE AS HOT SPARE

(76) Inventors: Nitin Kishore, Bangalore (IN); Saikat Biswas, Bangalore (IN); Siddharth Suresh Shanbhag, Bangalore (IN); Avijit Adak, Bangalore (IN)

(21) Appl. No.: 13/039,406

(22) Filed: Mar. 3, 2011

(51) Int. Cl. G06F 11/20

(52) U.S. Cl. 714/6.23; 714/E11.09

(57) ABSTRACT

Disclosed is a method of providing virtual volumes to at least one host. Physical drives are grouped. Data is mirrored within groups to create a RAID-1 protected virtual drive. Data is also mirrored from the first virtual drive on a second virtual drive to create a hot spare virtual drive to act as a replacement for the RAID-1 protected virtual drive.

### BACKGROUND OF THE INVENTION

Mass storage systems continue to provide increased storage capacities to satisfy user demands. Photo and movie storage, and photo and movie sharing are examples of applications that fuel the growth in demand for larger and larger storage systems.

A solution to these increasing demands is the use of arrays of multiple inexpensive disks. These arrays may be configured in ways that provide redundancy and error recovery without any loss of data. These arrays may also be configured to increase read and write performance by allowing data to be read or written simultaneously to multiple disk drives. These arrays may also be configured to allow “hot-swapping” which allows a failed disk to be replaced without interrupting the storage services of the array. Whether or not any redundancy is provided, these arrays are commonly referred to as redundant arrays of independent disks (or more commonly by the acronym RAID). The 1987 publication by David A. Patterson, et al., from the University of California at Berkeley titled “A Case for Redundant Arrays of Inexpensive Disks (RAID)” discusses the fundamental concepts and levels of RAID technology.

RAID storage systems typically utilize a controller that shields the user or host system from the details of managing the storage array. The controller makes the storage array appear as one or more disk drives (or volumes). This is accomplished in spite of the fact that the data (or redundant data) for a particular volume may be spread across multiple disk drives.

### SUMMARY OF THE INVENTION

An embodiment of the invention may therefore comprise a method of providing virtual volumes to at least one host, comprising: grouping a first plurality of physical drives into a first physical drive group, wherein the first plurality of physical drives comprises at least a first physical drive and a second physical drive; grouping a second plurality of physical drives into a second physical drive group, wherein the second plurality of physical drives comprises at least a third physical drive and a fourth physical drive; mirroring at least the first physical drive on the second physical drive to create a RAID-1 protected virtual drive; and, mirroring storage data from at least the first virtual drive on a second virtual drive created using at least a portion of said third physical drive and said fourth physical drive to create a hot spare virtual drive to act as a replacement for said RAID-1 protected virtual drive.

An embodiment of the invention may therefore further comprise a storage system, comprising: a physical drive grouper configured to provide a plurality of virtual drives that stripes a plurality of physical disks to provide a plurality of virtual drives that utilize RAID level 1; and, a hot spare manager configured to provide at least a first virtual volume to a first host that mirrors at least one of the plurality of virtual drives to a first virtual hot spare volume with that utilizes RAID level 1.

### BRIEF DESCRIPTION OF THE DRAWINGS

FIG. 1 is a block diagram illustrating a storage system.

FIG. 2 is a block diagram illustrating a storage system.

FIG. 3 is a flowchart of a method of operating a storage system.

FIG. 4 illustrates a block diagram of a computer system.

### DETAILED DESCRIPTION OF THE EMBODIMENTS

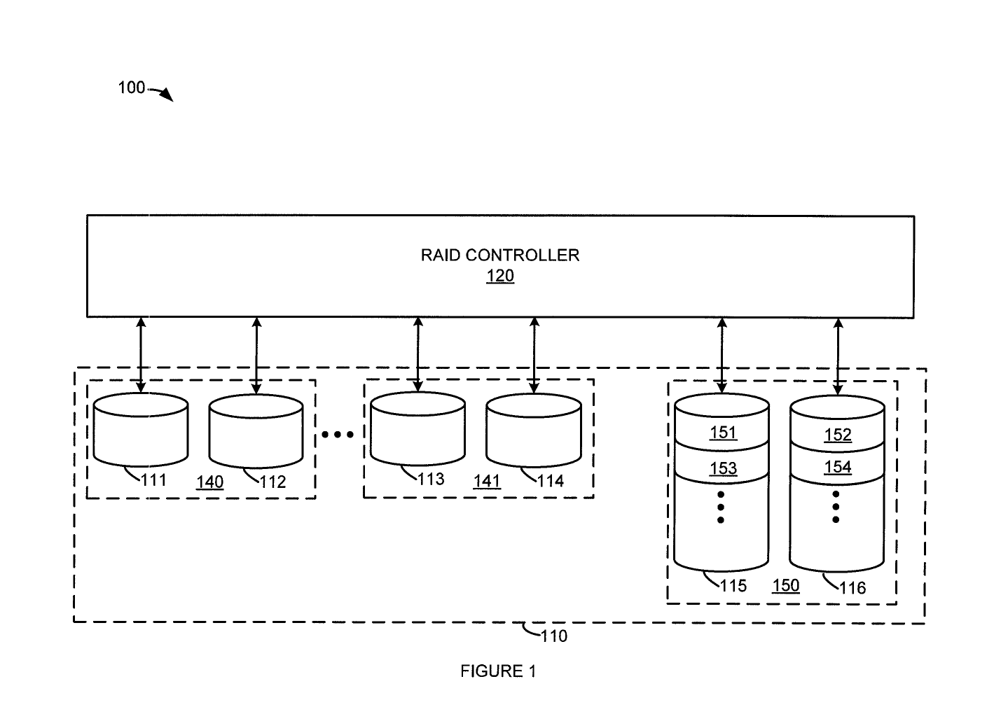

FIG. 1 is a block diagram illustrating a storage system. In FIG. 1, storage system 100 comprises an array of physical disks 110, RAID controller 120. Array of physical disks 110 is comprised of a plurality of RAID-1 groups projected as virtual drives 140, 141, and 150. These virtual drives are shown in FIG. 1 as RAID group 140, RAID group 141, and RAID group 150. RAID group 140 is comprised of drive 112 and drive 111. RAID group 141 is comprised of drive 113 and drive 114. RAID group 150 is comprised of drive 115 and drive 116. RAID group 150 has been sliced into multiple RAID-1 virtual drives. A first RAID-1 virtual drive is comprised of drive slices 151 and 152. A second virtual drive is comprised of drive slices 153 and 154.

In an embodiment, drive slices 151 and 152 act as a hot spare device for drive group (virtual drive) 140. Drive slices 153 and 154 act as a hot spare device for drive group 141. In an embodiment, there are pairs of drive slices 151-154 acting as a virtual drive hot spare for each of the drive groups in array of physical disks 110. Thus, if any of the given drive group 140-141 becomes degraded, the particular RAID-1 slice of RAID group 150 can act as global or dedicated hot spare to that drive group 140-141. The particular RAID-1 slice of RAID group 150 will be activated as part of the degraded drive group 140-141. This allows a rebuild to start. Data redundancy will be present after the rebuild.

In an embodiment, the number of disks that are used for hot spares is reduced. Even with a reduced number of hot spares, data redundancy data redundancy is provided. This means that when one of the disks 115-116 responsible for the hot spare capacity fails, data redundancy provided by the RAID-1 nature of drive group 150 will still exist.

In an embodiment, Disk Drive Format (DDF) information is provided on the individual drive groups 140-141, 150. When the virtual drives created are provided with individual DDF, and when the firmware can update the same DDF to the hot spare virtual drive 150, the sliced RAID-1 hot spare virtual drive (e.g., 151 & 152 or 153 & 154) belonging to that virtual drive (140 or 141) is activated. This ensures that mirroring continues and data redundancy continues to be present.

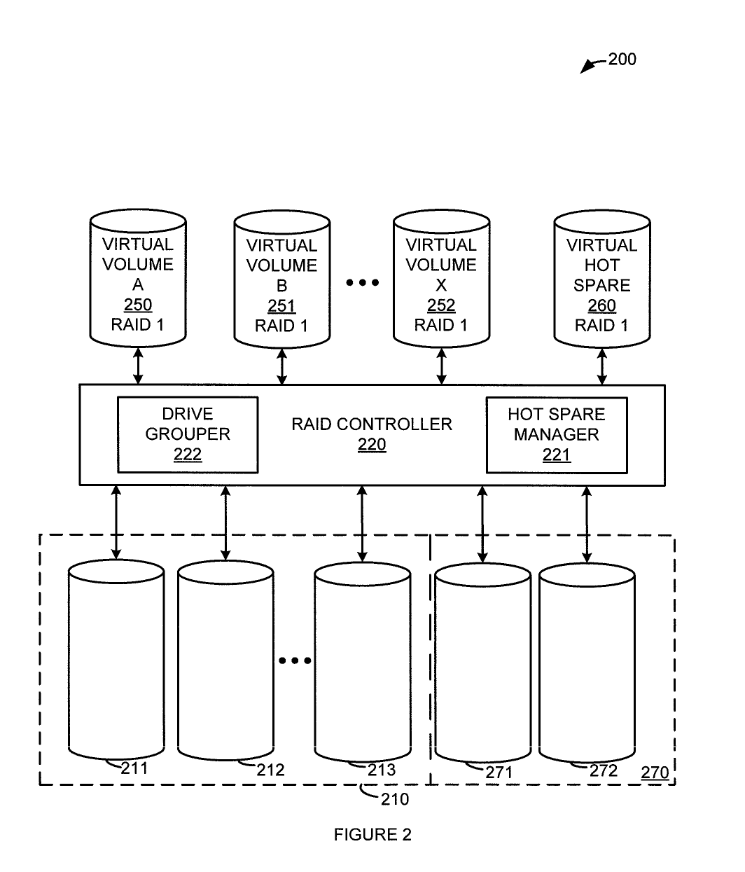

FIG. 2 is a block diagram illustrating a storage system. In FIG. 2, storage system 200 is comprised of disk array 210, RAID controller 220, virtual volume 250, virtual volume 251, virtual volume 252, and virtual hot spare 260. Disk array 210 includes at least first physical drive 211, second physical drive 212, third physical drive 213, fourth physical drive 271, and fifth physical drive 272. Disk array 210 may also include more disk drives. However, these are omitted from FIG. 2 for the sake of brevity. RAID controller 220 includes drive grouper 222 and hot spare manager 221. Hot spare manager 221 may support all RAID levels. Disk array 210, and physical drives 211-213, 271-272, are operatively coupled to RAID controller 220. Thus, RAID controller 220 may operate to control, span, and/or stripe physical drives 211-213, 271-272 into virtual volumes 250-252, and/or virtual hot spare 260. RAID controller 220 may also operate to control, span, and/or stripe physical drives 271-272 into a RAID-1 protected group 270.

One or more of physical drives 211-213, 271-272 may store disk data format information. One or more of physical drives 211-213, 271-272 may be configured by RAID controller 220 as one or more of virtual volumes 250-252 and/or virtual hot spare 260. RAID controller 220 may configure physical drives 211-213, 271-272, virtual volumes 250-252, and/or virtual hot spare 260 to provide RAID level 1 (RAID-1) protection. One or more of virtual volumes 250-252, and/or virtual hot spare 260 may store disk data format information.

Raid controller 220 includes hot spare manager 221. Hot spare manager 221 may be a module or process that configures virtual hot spare 260 as a virtual drive hot spare for one or more of virtual volumes 250-251. Hot spare manager 221 may include dedicated hardware to increase the performance of accesses to physical drives 211-213, 271-272. Hot spare manager 221 can use two physical drives 271 and 272 to form a RAID-1 configuration for virtual hot spare 260.

In an embodiment, drive grouper 222 creates a plurality of virtual drives 250-252 and 260 by grouping one or more physical drives 211-213, 271-272 in one or more RAID configurations and then projecting the RAID protected storage space as individual virtual drives. In other words, drive grouper 222 creates virtual drives whose data is entirely mirrored on more than one physical drive 211-213, 270-271. These virtual drives may appear to RAID controller 220, or other software modules, as single, unmirrored disk drives. If any of the given virtual volumes 250-251 got degraded (i.e., if a physical drive corresponding to a virtual volume 250-252 failed) virtual hot spare 260 (with RAID-1 protection corresponding to particular slices of physical drives 271-272) can act as global or dedicated hot spare to that virtual volume. The sliced RAID-1 virtual hot spare 260 can act as part of a degraded drive group and a rebuild will start. Data redundancy will be present after rebuild since the nature of RAID-1 supports one drive failure. Once a failed physical drive is replaced, the data may be copied back from virtual hot spare 260 to the replacement drive.

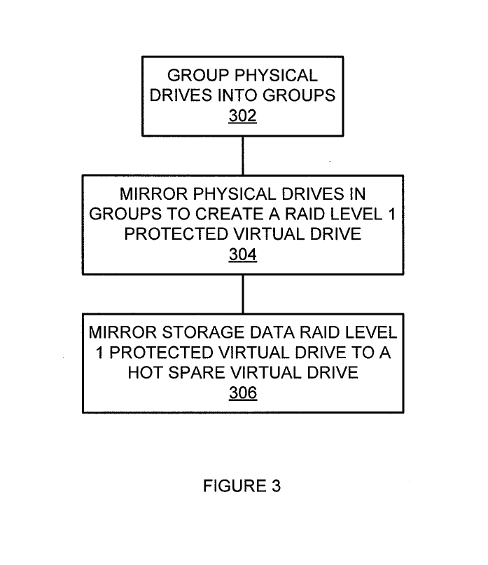

FIG. 3 is a flowchart of a method of operating a storage system. The steps illustrated in FIG. 3 may be performed by one or more elements of storage system 100 or storage system 200. Physical drives are grouped (302). For example, RAID controller 220 may group physical drives 211-213. Physical drives in these groups are mirrored to create a RAID level 1 protected virtual drive (304). For example, RAID controller 220 may mirror the data on physical drives 211-213 to the other disk(s) in the drive group (or slices of physical drives 211-213) to form RAID-1 protected virtual volumes 250-252, and/or virtual hot spare 260. The data on the RAID level 1 protected virtual drive is mirrored to a hot spare virtual drive (306). For example, if virtual volume 250 becomes degraded, RAID controller 220 may mirror the data on virtual volume 250 (or all or part of one of the physical drives that comprise virtual volume 250) to virtual hot spare 260. Thus, virtual hot spare 260 may act as a replacement for all or part of virtual volume 250 (or all or part of one of the physical drives that comprise virtual volume 250). In another embodiment, multiple virtual hot spares may be created and act as replacements for multiple virtual volumes 250-252.

The systems, software, computers, disk drives, controller, and functions described above may be implemented with or executed by one or more computer systems. The methods described above may be stored on a computer readable medium. Many of the elements of storage system 100 or storage system 200 may be, comprise, or include computers systems. This includes, but is not limited to RAID controller 120, RAID controller 220, disk drives 111-116, and disk drives 211-213.

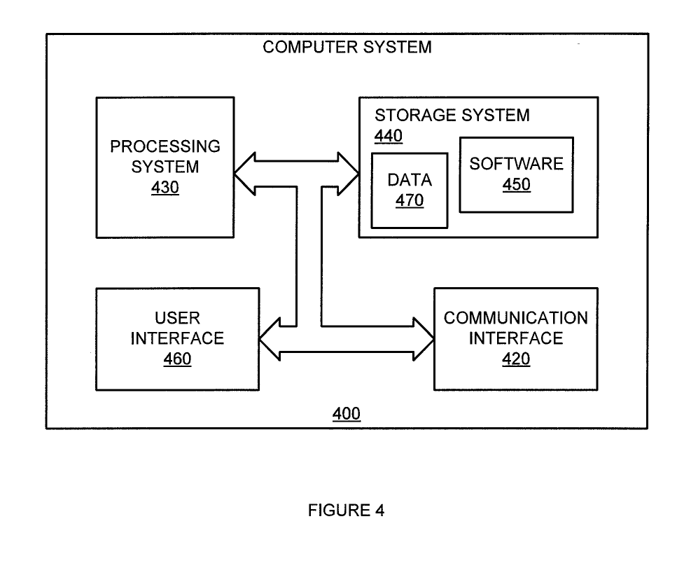

FIG. 4 illustrates a block diagram of a computer system. Computer system 400 includes communication interface 420, processing system 430, storage system 440, and user interface 460. Processing system 430 is operatively coupled to storage system 440. Storage system 440 stores software 450 and data 470. Processing system 430 is operatively coupled to communication interface 420 and user interface 460. Computer system 400 may comprise a programmed general-purpose computer. Computer system 400 may include a microprocessor. Computer system 400 may comprise programmable or special purpose circuitry. Computer system 400 may be distributed among multiple devices, processors, storage, and/or interfaces that together comprise elements 420-470.

Communication interface 420 may comprise a network interface, modem, port, bus, link, transceiver, or other communication device. Communication interface 420 may be distributed among multiple communication devices. Processing system 430 may comprise a microprocessor, microcontroller, logic circuit, or other processing device. Processing system 430 may be distributed among multiple processing devices. User interface 460 may comprise a keyboard, mouse, voice recognition interface, microphone and speakers, graphical display, touch screen, or other type of user interface device. User interface 460 may be distributed among multiple interface devices. Storage system 440 may comprise a disk, tape, integrated circuit, RAM, ROM, network storage, server, or other memory function. Storage system 440 may be a computer readable medium. Storage system 440 may be distributed among multiple memory devices.

Processing system 430 retrieves and executes software 450 from storage system 440. Processing system may retrieve and store data 470. Processing system may also retrieve and store data via communication interface 420. Processing system 450 may create or modify software 450 or data 470 to achieve a tangible result. Processing system may control communication interface 420 or user interface 470 to achieve a tangible result. Processing system may retrieve and execute remotely stored software via communication interface 420.

Software 450 and remotely stored software may comprise an operating system, utilities, drivers, networking software, and other software typically executed by a computer system. Software 450 may comprise an application program, applet, firmware, or other form of machine-readable processing instructions typically executed by a computer system. When executed by processing system 430, software 450 or remotely stored software may direct computer system 400 to operate as described herein.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of providing virtual volumes to at least one host, comprising:
grouping a first plurality of physical drives into a first physical drive group, wherein the first plurality of physical drives comprises at least a first physical drive and a second physical drive;
grouping a second plurality of physical drives into a second physical drive group, wherein the second plurality of physical drives comprises at least a third physical drive and a fourth physical drive;
mirroring at least the first physical drive on the second physical drive to create a RAID-1 protected virtual drive; and,
mirroring storage data from at least the first virtual drive on a second virtual drive created using at least a portion of said third physical drive and said fourth physical drive to create a hot spare virtual drive to act as a replacement for said RAID-1 protected virtual drive.

2. The method of claim 1, further comprising:
creating a plurality of hot spare virtual drives to act as replacements for a plurality of RAID-1 protected virtual drives.

3. The method of claim 2, further comprising:
in response to a failed physical drive that corresponds to a failed virtual drive, storing information that was previously stored on said failed physical drive on one of said plurality of hot spare virtual drives.

4. The method of claim 3, further comprising:
copying information stored on said one of said plurality of hot spare virtual drives to a replacement physical drive that has replaced said failed physical drive.

5. The method of claim 1, wherein said creating said hot spare virtual drive to act as a replacement for said RAID-1 protected virtual drive comprises:
retrieving a first block of data from the first virtual drive; and, retrieving a mirrored copy of the first block of data from the second virtual drive.

6. The method of claim 1, wherein said RAID-1 protected virtual drive stores disk data format (DDF) information.

7. The method of claim 1, wherein said hot spare virtual drive stores disk data format (DDF) information.

8. The method of claim 1, wherein disk data format information (DDF) is updated on said hot spare virtual drive based on DDF information stored on said RAID-1 protected virtual drive.

9. A storage system, comprising:
a physical drive grouper configured to provide a plurality of virtual drives that stripes a plurality of physical disks to provide a plurality of virtual drives that utilize RAID level 1;
a hot spare manager configured to provide at least a first virtual volume to a first host that mirrors at least one of the plurality of virtual drives to a first virtual hot spare volume with that utilizes RAID level 1.

10. The storage system of claim 9, wherein the hot spare manager stripes the plurality of virtual drives to provide virtual hot spare volume with RAID level 1.

11. The storage system of claim 9, wherein said plurality of virtual drives store disk data format (DDF) information.

12. The storage system of claim 9, wherein said virtual hot spare volume stores disk data format (DDF) information.

13. The storage system of claim 9, wherein disk data format information (DDF) is updated on said virtual hot spare volume based on DDF information stored on at least one of said plurality of virtual drives.

14. A computer readable medium having instructions stored thereon for providing virtual volumes to at least one host that, when executed by a computer, at least direct the computer to:
group a first plurality of physical drives into a first physical drive group, wherein the first plurality of physical drives comprises at least a first physical drive and a second physical drive;
group a second plurality of physical drives into a second physical drive group, wherein the second plurality of physical drives comprises at least a third physical drive and a fourth physical drive;
mirror at least the first physical drive on the second physical drive to create a RAID-1 protected virtual drive; and,
mirror storage data from at least the first virtual drive on a second virtual drive created using at least a portion of said third physical drive and said fourth physical drive to create a hot spare virtual drive to act as a replacement for said RAID-1 protected virtual drive.

15. The computer readable medium of claim 14, wherein the computer is further instructed to:
create a plurality of hot spare virtual drives to act as replacements for a plurality of RAID-1 protected virtual drives.

16. The computer readable medium of claim 15, wherein the computer is further instructed to:
in response to a failed physical drive that corresponds to a failed virtual drive, storing information that was previously stored on said failed physical drive on one of said plurality of hot spare virtual drives.

17. The computer readable medium of claim 16, wherein the computer is further instructed to:
copy information stored on said one of said plurality of hot spare virtual drives to a replacement physical drive that has replaced said failed physical drive.

18. The computer readable medium of claim 14, wherein creating said hot spare virtual drive to act as a replacement for said RAID-1 protected virtual drive comprises:
retrieving a first block of data from the first virtual drive; and, retrieving a mirrored copy of the first block of data from the second virtual drive.

19. The computer readable medium of claim 16, wherein, wherein said RAID-1 protected virtual drive stores disk data format (DDF) information.

20. The computer readable medium of claim 16, wherein said hot spare virtual drive stores disk data format (DDF) information.
